(19) United States
(12) Patent Application Publication
(10) Pub. No.: US 2006/0222451 A1
(43) Pub. Date: Oct. 5, 2006

(54) Oral care systems having replaceable toothbrush and dentifrice units

(76) Inventor: Karen L. Glassman, New York, NY (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 11/096,757

(22) Filed: Apr. 1, 2005

(51) Int. Cl. B43K 5/06; B43M 11/06; A47L 13/22

(52) U.S. Cl. 401/270; 401/277; 401/286; 401/291; 401/183

(57) ABSTRACT

The present invention provides oral care systems having an integral brush/dentifrice compartment and a self-contained dentifrice delivery system. The systems include a substantially permanent handle unit and a replaceable/disposable brush/dentifrice compartment unit. The brush/dentifrice compartment unit preferably is constructed as a single-piece and is insertable into the handle unit. The brush/dentifrice compartment unit includes an integral and self-contained dentifrice dispensing system that eliminates the need for a separate dentifrice container and therefore provides a more effective and sanitary dentifrice delivery system.

### FIELD OF THE INVENTION

The present invention relates generally to an oral care systems and more particularly to systems comprising a substantially permanent handle unit and a replaceable unit that, in turn, comprises a toothbrush and dentifrice storage compartment and dentifrice delivery system.

### BACKGROUND OF THE INVENTION

Conventional toothbrushes include an elongate handle and a brush having a plurality of bristles. Typically, a paste, gel, or some other suitable dentifrice is stored in a separate container and is dispensed by a user onto the bristles for brushing the user's teeth. One recognized way to prevent tooth decay and periodontal disease is through regularly brushing of teeth and gums. Tooth decay results when the bacteria in plaque feed on carbohydrates (sugar and starch) in the user's diet to produce acids. Brushing removes decay-causing plaque and other contaminants from the tooth surfaces and freshen breath.

The American Dental Association (ADA) recommends that people brush their teeth twice a day with a fluoride toothpaste for good oral hygiene. Good oral hygiene also requires that the brush be replaced periodically in order to maintain the effectiveness of the toothbrush for cleaning. The bristles need to be flexible and soft so that they do not damage the gums and teeth during brushing. The bristles eventually become worn and/or damaged (broken, bent, frayed, etc.) as a result of repeated brushing. The ADA recommends that people replace a toothbrush every three or four months, or sooner if the bristles become worn and/or damaged. A damaged or worn toothbrush will not do a good job of cleaning teeth. In addition, microbes can grow on toothbrush bristles and the brush head. Although most microbes are harmless, others can be harmful, such as the cold and flu viruses, the herpes virus that causes cold sores, and bacteria that can cause periodontal infections.

Conventional toothbrush systems typically require a separate container for the storage and dispensing of dentifrice. Common types of dentifrice materials include powders, pastes, gels, and liquids. Separate dentifrice containers typically have caps that can become lost and/or contaminated. Toothpaste may also be inadvertently discharged from these separate containers causing a mess on sinks, cabinets, counters, travel containers, cosmetic cases and suit cases. In addition, the use of separate containers for holding the toothpaste or gel may also lead to other sanitary problems. For example, the dispensing opening of the separate container can also become contaminated in the bathroom environment and during packing for travel. Furthermore, when multiple users share a single toothpaste container, there can be cross-contamination of the individual toothbrushes when the dispensing opening of the separate container touches the bristles of the toothbrushes of different users.

Another problem with conventional toothbrush systems is that the handle is typically discarded along with the entire toothbrush system because the brush portion has failed. This is true even though the handle is typically still in good working condition. The handle portion is very durable and typically outlasts the useful life of the brush and the supply of toothpaste in the separate toothpaste container. It is desirable to reuse the portions of the toothbrush system that are still in good working condition.

Certain users, such as the elderly, arthritis suffers, and children, have difficulty in manually dispensing the toothpaste. Such users may find it desirable to have a toothbrush system having an automatic dispensing systems for applying the toothpaste on the brush. Some users also find automatic brushing systems for vibrating, rotating, and/or oscillating the brush to be desirable. But these automatic dispensing systems and/or automatic brushing systems add a signification portion to the overall cost of the toothpaste system and therefore it is desirable to reuse the automatic dispensing system.

A need exists for a toothbrush system that solves one or more of the above-identified problems.

### SUMMARY OF THE INVENTION

The invention provides an oral care system, such as a toothbrush system, having a handle unit and a brush/dentifrice compartment unit. Preferred systems include a substantially permanent handle unit and a replaceable brush/dentifrice compartment unit. Preferably, the brush/dentifrice compartment unit is constructed as a single-piece and includes an integral and self-contained dentifrice dispensing system that eliminates the need for a separate dentifrice container and therefore provides a more effective and sanitary dentifrice delivery system.

In one embodiment, the oral care system includes a handle having a cavity therein. A compartment storing a dentifrice material is replaceably disposed in the cavity. The oral care system includes a brush having a plurality of bristles extending from a head and one or more apertures in the head proximate the bristles. A neck extends between and connects the brush and the compartment and includes a passageway that fluidly connects the compartment and the apertures. The brush, neck, and compartment are formed as a substantially integral unit that is detachably connected to the handle.

According to another aspect of the invention, the brush, neck, and compartment are non-detachably connected to one another to form a self-contained dentifrice dispensing system.

According to another embodiment of the invention, the oral care system includes a dispensing mechanism for compressing the compartment. In one embodiment, the dispensing mechanism includes a base positioned within the cavity for engaging the compartment, a stem connected to the base at a first end, and a control knob connected to a second end of the stem opposite the fist end. The knob is accessible from an exterior of the handle and the base travels upward and compresses the compartment when the knob is activated.

According to another aspect of the invention, an encasement can be provided to protect the compartment. In one embodiment, the encasement extends from the neck and surrounds the compartment. The encasement can include an opening at a bottom end, wherein the base of a dispensing system can pass through the opening and travel upward into the encasement as the dispensing system is activated to compress the compartment.

According to another embodiment of the invention, the oral care system further includes an opening in a top end of the handle and a rigid neck extends through the opening in the top end of the handle. In one embodiment, the neck is releaseably connected to the handle proximate the opening in the top end of the handle. The neck can form a snap-fit connection with the opening in the top end of the handle. The handle can include deflectable arms proximate the opening in the top end of the handle that deflect outward when the neck is inserted into or removed from the opening. Once the neck snaps into the opening in the top end of the handle, the arms hold the neck to the handle. Alternatively, the neck can be held to the handle using other means, such as threads, wherein the neck is threadably connected to the handle, a retainer ring, wherein the retainer ring releaseably connects the neck to the handle, and the like.

According to another embodiment of the invention, the oral care system further includes a handle neck connected to and extending from a top end of the handle, a channel formed in the handle neck for receiving and retaining the neck, a handle head at a top end of the handle neck, and a recess formed in the handle head for receiving and retaining the brush head. The neck is releaseably connected to the channel in the handle neck and the brush head is releaseably connected to the recess in the handle head. In one embodiment, the neck forms a snap-fit connection with the channel in the handle neck and the brush head forms a snap-fit connection with the recess in the handle head. This type of handle can be used where the neck is flexible.

According to another aspect of the invention, a door can be provided to protect the compartment. The door can be connected to the handle and overlays the compartment positioned in the cavity. The door can be connected to the handle body by hinges, or other suitable means, so that the door can by moved out of the way to access the handle cavity to insert/remove a brush/dentifrice compartment unit.

According to another aspect of the invention, an ejector may be provided in the handle for assisting in the ejection of a brush/dentifrice compartment unit from the handle. One or more grips may also be provided in the handle. The handle may also include a timer.

According to another aspect of the invention, one or more bristle tubes may be provided to enhance the dispensing of the dentifrice at the bristles. The bristle tubes are connected to the dentifrice dispensing apertures in the brush head and extend from the brush head between the bristles.

According to another embodiment of the invention, the oral care system may also include an automatic toothbrush system. The automatic toothbrush system includes a power supply and a motor. In one embodiment, the automatic toothbrush system includes an automatic dentifrice dispensing system having linkage connected between an output shaft of the motor and a base and a dentifrice dispensing button electrically coupled between the power supply and the motor. The power supply energizes the motor when the dentifrice dispensing button is activated, the motor causes the motor output shaft to rotate and the linkage to move the base and compress the compartment causing dentifrice to be dispensed at the bristles.

In another embodiment, the automatic toothbrush system includes an automatic brushing system. The automatic brushing system includes linkage connected to an output shaft of the motor and the brush head and an on/off button electrically coupled between the power supply and the motor. The power supply energizes the motor when the on/off button is activated, the motor causes the motor output shaft to rotate and the linkage to one of vibrate, rotate, and oscillate one of the brush head and the bristles for improved oral hygiene.

In yet another embodiment, the automatic toothbrush system includes an automatic dentifrice dispensing system and an automatic brushing system.

The automatic toothbrush system can include a base for cradling and recharging the automatic toothbrush system. The automatic toothbrush system can be electrically operated or battery operated. The batteries can be rechargeable.

According to another aspect of the invention, a cover can be provided for enclosing and protecting at least the brush head and the bristles. In addition, a separate case can be provided for enclosing and protecting the brush/dentifrice compartment unit when it is removed from the handle unit.

The invention also provides an oral care system comprising a handle portion and a brush/dentifrice compartment portion that is detachably coupled to the handle portion. The handle portion includes a rigid body, a cavity in the body, and an opening in a top end of the handle body. The brush/dentifrice compartment portion includes a rigid brush head, a plurality of flexible bristles extending from the brush head, one or more dentifrice dispensing apertures in the brush head proximate the bristles, a rigid neck formed between the brush head and the compartment. The neck extends through the opening in the top end of the handle portion. A collapsible compartment storing a dentifrice material is positioned within the cavity. A passageway passes through the neck and fluidly connects the compartment to the one or more dentifrice dispensing apertures. Preferably, the compartment, passageway, and apertures form a self-contained dentifrice dispensing system.

The invention further provides an toothbrush and dentifrice storage sub-system including a brush portion and a dentifrice storage portion. The brush portion includes a rigid platform, a plurality of bristles extending from one side of the platform, one or more apertures in the platform proximate the bristles, an elongate neck extending from the platform, and a passageway in the elongate neck fluidly connected to the one or more apertures. The dentifrice storage portion is non-detachably connected to the brush portion and includes a flexible wall defining a belly, an opening in the flexible wall, the opening fluidly connected to the passageway, and a dentifrice material stored within the belly. The dentifrice material flows from the belly, through the opening in the flexible wall, through the passageway in the neck, and through the one or more dispensing apertures in the head portion. Preferably, the brush portion and the dentifrice storage portion are formed as a single, integral unit having a self-contained dentifrice dispensing system.

According to another aspect of the invention, a package can be provided for holding one or more of the toothbrush and dentifrice storage sub-systems. The package preferably holds various replaceable toothbrush and dentifrice storage sub-systems, including various size and shape brush portions and various type and flavor dentifrice storage portions.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary embodiments of the invention; however, the invention is not limited to the specific methods and instrumentalities disclosed. In the drawings:

FIG. 1 is a perspective view of an exemplary toothbrush system with a permanent handle unit and a replaceable brush/dentifrice unit;

FIG. 2 is an exploded perspective view of the toothbrush system of FIG. 1 showing the replaceable brush/dentifrice unit separate from the handle unit;

FIG. 3 is a partial cross-sectional side view of the exemplary toothbrush system showing a passageway fluidly connecting the dentifrice compartment to the brush head;

FIG. 4 is an exploded perspective view of another exemplary toothbrush system showing an encasement surrounding the compartment;

FIG. 5 is a cross-sectional side view of an exemplary brush showing exemplary dentifrice dispensing tubes;

FIG. 6 is a front view of another exemplary toothbrush system having a handle unit and a replaceable brush/dentifrice unit;

FIG. 7 is a partial cross-sectional front view of another exemplary embodiment showing a twist-type manual dentifrice dispensing system;

FIG. 8 is a partial cross-sectional view of a brush/dentifrice compartment unit having an encasement surrounding the compartment and showing a portion of a dispensing system;

FIG. 9 is a cross-sectional front view of another exemplary embodiment showing an automatic toothbrush system;

FIG. 10 is a rear view of the exemplary automatic toothbrush system;

FIG. 11 shows an electric toothbrush system mounted in a base for recharging;

FIG. 12 shows an exemplary brush cover that can be used with the toothbrush system;

FIG. 13 shows an exemplary case that can be used to store the brush/dentifrice unit during travel; and

FIG. 14 is an exemplary package for holding one or more replacement toothbrush and dentifrice storage sub-systems.

### DETAILED DESCRIPTION OF ILLUSTRATIVE EMBODIMENTS

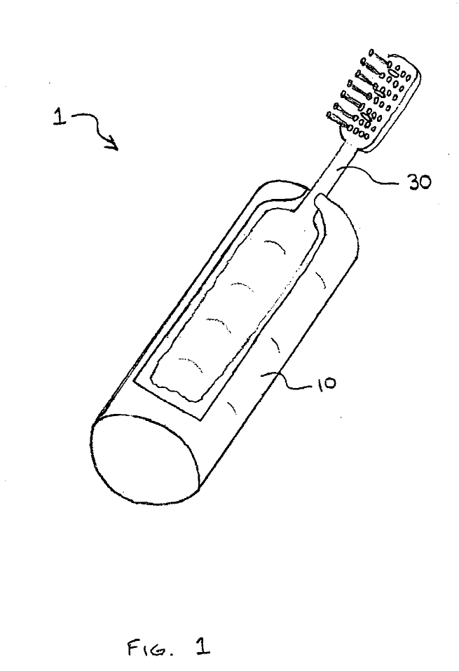

Several exemplary embodiments of oral care systems in accordance with the present invention are shown in FIGS. 1-14. The present invention is directed to oral care systems that are easier and more efficient to use and provide improved sanitation. More particularly, the present invention provides replaceable systems having an integral brush and dentifrice storage compartment and a self-contained dentifrice delivery system.

Preferred systems include a substantially permanent handle unit and a replaceable/disposable unit that comprises a brush and a dentifrice compartment. The brush/dentifrice compartment unit can be constructed as a single-piece that is insertable into the handle unit. The brush/dentifrice compartment unit preferably includes an integral and self-contained dentifrice dispensing system that eliminates the need for a separate dentifrice container and therefore provides a more effective and sanitary dentifrice delivery system. When the supply of dentifrice stored in the compartment has been depleted, the entire brush and compartment unit can be easily removed from the handle unit and discarded. A new brush/dentifrice compartment unit can be inserted into the handle unit for the next brushing. Also, the brush/dentifrice compartment unit may be removed from the handle unit after each brushing, and another such unit, or the same unit, can be inserted into the handle unit for the next brushing.

The self-contained brush/dentifrice compartment unit eliminates and/or significantly reduces the chance of any contaminates entering or mixing with the dentifrice prior to and during use. Having the dentifrice compartment formed integral with the brush also eliminates and/or significantly reduces messy sinks, counters and cabinets. The replaceable brush/dentifrice compartment unit also allows for periodic replacement of the brush bristles for improved oral hygiene. This also enables the user to change the brush on a more regular basis without thinking about when the brush was last changed. Also, since the brush/dentifrice compartment unit is insertable and removable, multiple users can share the same handle unit or the same user can change brush types and/or the type of dentifrice between brushes. Further, many of the non-consumable and non-wear parts of the system can be reused.

The toothbrush system can include a manual system, a partial manual and partial automatic system, or an automatic system. For example, a fully manual toothbrush system can include a manual dentifrice dispensing system and manual brush head. A partially manual and partially automatic system can include an automatic dentifrice dispensing system and manual brush head or vice-versa, and a fully automatic system would have an automated dentifrice dispensing system and an automatic brushing system. An automatic toothbrush system could include, for example, battery power, electric power, etc.

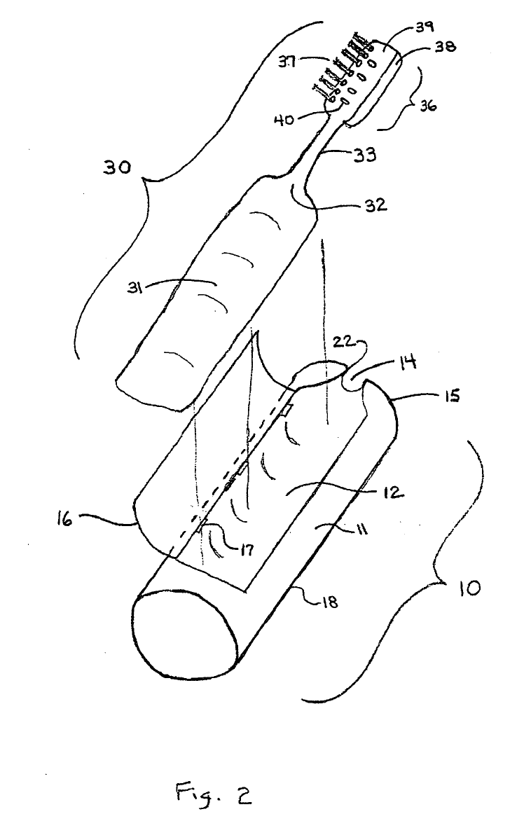

FIGS. 1 and 2 are perspective views of an exemplary toothbrush system 1. As shown, the toothbrush system 1 includes a handle unit 10 and a brush/dentifrice compartment unit 30. The handle unit 10 is preferably a permanent unit that can be used for a relatively long period of time, including use over the useful life of multiple brush/dentifrice compartment units 30. The brush/dentifrice compartment unit 30 is formed as a single integral unit and is self-contained with no detachable connections in the dentifrice dispensing system between the dentifrice storage compartment and the brush.

The brush/dentifrice compartment unit 30 is inserted into the handle unit 10 prior to use (as shown in FIG. 1) and may be selectively removed from the handle unit 10 after the supply of dentifrice is depleted or between brushings if desired (as shown in FIG. 2). FIG. 2 is an exploded perspective view showing the brush/dentifrice compartment unit 30 removed and separate from the handle unit 10. The brush/dentifrice compartment unit 30 can be discarded once the supply of dentifrice material stored in the compartment 31 is depleted and a new brush/dentifrice compartment unit 30 having a new supply of dentifrice and new bristles 37 can be inserted.

As shown in FIGS. 1-4 and 6, the handle unit 10 includes a body 11. The handle unit 10 preferably includes an elongate body 11. The handle unit 10 is preferably formed from a hard plastic material, although other materials may be suitable for construction of the handle 10. A cavity 12 is formed in the body 11. The cavity 12 is sized to receive and hold a compartment 31. In one embodiment, the handle 10 includes a hollow body or shell defining the cavity 12. As shown in FIGS. 1-4 and 5, an opening 14 is formed at the top end 15 of the handle 10. The opening 14 can include a generally U-shaped opening that receives and engages the brush/dentifrice compartment unit 30 and holds the brush/dentifrice compartment unit 30 in place.

As shown, the brush/dentifrice compartment unit 30 extends through the opening 14 in the top end 15 of the handle 10. The brush/dentifrice compartment unit 30 is releaseably connected to the handle 10 proximate the opening 14 in the top end 15 of the handle 10. In one preferred embodiment, the brush/dentifrice compartment unit 30 forms a snap-fit connection within the opening 14 of the handle unit 10. For example, deflectable arms 22 can be formed proximate the opening 14 and the arms 22 can deflect outward when the brush/dentifrice compartment unit 30 is being inserted into and/or removed from the opening 14 in the top end 15 of the handle 10.

Alternative means can be used to releaseably connect the brush/dentifrice compartment unit 30 to the handle unit 10. For example, the connection between the brush/dentifrice compartment unit 30 and the handle unit 10 can include a threaded connection, a retainer ring, a latch mechanism, and the like (not shown).

As shown in FIG. 2, the handle unit 10 may include a door 16 for covering the cavity 12. In one embodiment, a door 16 is connected to the handle body 10 using one or more hinges 17 and the door 16 may pivot about the hinged connection to selectively open and close the door 16. As shown in FIG. 2, the door 16 is opened to insert and/or remove a brush/dentifrice compartment unit 30 from the cavity 12 of the handle unit 10. The door 16 is closed when a brush/dentifrice compartment unit 30 is positioned within the cavity 12. Alternatively, the door 16 can be attached to the handle body 11 via other suitable means, such as a slider, a snap fit, and the like (not shown).

Preferably, the door 16 is a see-through material, such as for example, a clear plastic material, that allows the user to see the compartment 31 in order to access the status of the compartment 31, such as, for example, to determine the type of dentifrice that is inserted in the handle 10, the amount of dentifrice that remains in the compartment 31, etc. Other means may be employed to provide an indication of the status of the dentifrice in the compartment 31. For example, a window (not shown) may be provided in the sidewall of the handle body, a sliding indicator (not shown) may extend through a slot in the sidewall of the handle body, a gauge which indicates amount of dentifrice remaining, etc.

Other suitable doors and/or covers are also contemplated. For example, the sidewall 18 of the handle body 11 may be continuous around the perimeter and a top (not shown) of the handle unit 10 may be detachable from the body 11. The top can be twisted onto and off of the body (similar to a lid on ajar). A portion of the brush/dentifrice compartment unit 30 would be fitted in a slot in the top and then the top can be secured back onto the body (by, for example, twisting the top into place). Once the supply of dentifrice is depleted, the top would be removed from the body 11 and the brush/dentifrice compartment unit 30 removed and discarded.

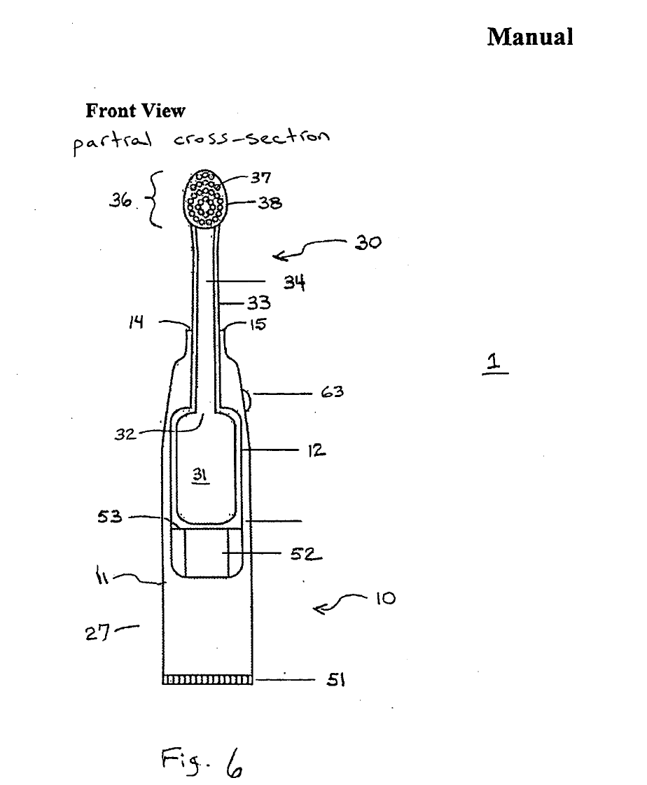

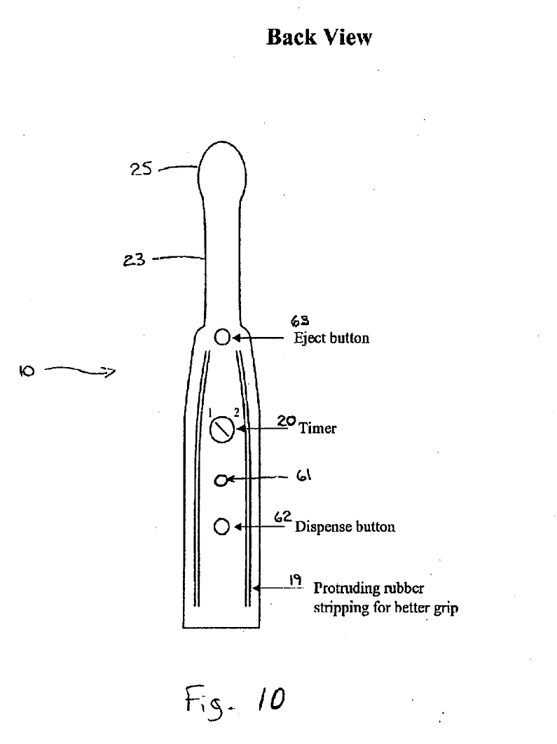

The handle 10 may include an ejector 63 for ejecting the brush/dentifrice compartment unit 30 from the handle unit 10. As shown in FIGS. 6 and 10, the ejector mechanism preferably includes a simple mechanical device, such a push button and stem that disengages the brush/dentifrice compartment unit 30 from the handle unit 10 when the ejector mechanism is activated by the user.

The handle may also include a grip 19 for improved handling by the user. The grip 19 is preferably a high friction material that prevents and/or reduces slippage of the toothbrush handle 10 in the user's hand. Preferably, the grip 19 is suitable for and has non-slip characteristics in a water environment typical of toothbrush systems. As shown in FIG. 10, indented rubber strips 19 may be provided on the handle to reduce slippage of the handle in a user's hand during brushing.

The handle 10 may also include a timer 20 as shown in FIG. 10. The timer 20 can be used to ensure that the user brushes for the recommended time to ensure proper cleaning of the teeth and assist with better oral hygiene. For example, a one/two minute timer may be provided on the handle to encourage children to brush for a predetermined amount of time. Preferably, the timer 20 is settable by the user and provides an indication, such as a visual or audio indication, when the desired time has been reached. In another embodiment the toothbrush system can include a timer with an automatic shut-off feature.

Preferably, the body 11 of the handle unit 10 has an ergonomic shape that fits comfortably in the hand of he user during brushing. Preferably, the handle unit 10 is sized for different users. For example, the size of the handle unit 10 can be design for different size users, such as adults and children. Preferably, the shape of the handle unit 10 is designed for different users. For example, the exterior shape of the handle 10 can be designed for right-handed persons or for left-handed persons. The handles may come in various colors and patterns, as well.

The brush/dentifrice compartment unit 30 is preferably formed as a single integral unit with no detachable connections between adjoining pieces or components. The brush/dentifrice compartment unit 30 includes a compartment 31, a neck 33, and a brush 36.

The compartment 31 includes a soft pliable material or belly. The compartment 31 defines a volume for the storage of a dentifrice material (e.g., a teeth cleaning and/or preserving substance). The compartment 31 includes an opening 32 that allows dentifrice stored in the compartment 31 to be expelled from the compartment 31. Preferably, the compartment material collapses as the dentifrice is expelled from the compartment 31. In certain embodiments, the compartment 31 may include clear material so that the dentifrice contained within the compartment 31 is visible to the user. This allows the user to ascertain a status of the dentifrice, such as the type of dentifrice, the amount of dentifrice remaining, etc. Preferably, the compartment 31 can store a supply of dentifrice suitable for multiple brushes. More preferably, the compartment 31 can store a supply of dentifrice suitable for the useful life of the brush 36.

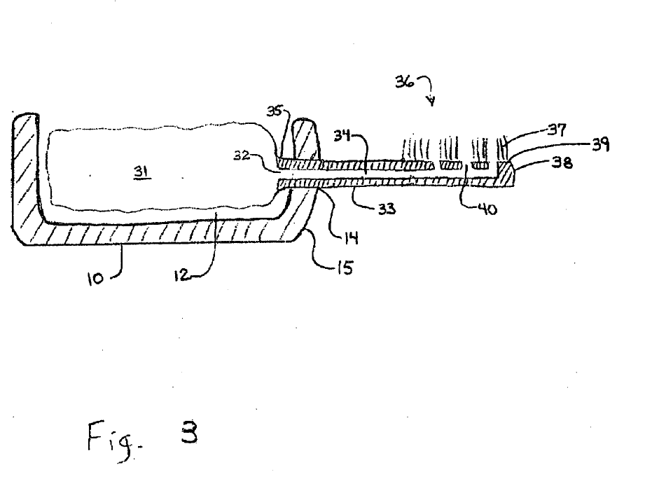

The neck 33 is connected to the compartment 31. As shown in FIG. 3, the neck 33 includes a passageway 34 for allowing a flow of dentifrice material (not shown) to flow through the neck 33. A first end 35 of the passageway 34 is fluidly connected to the opening 32 in the compartment 31. Preferably, the neck 33 is non-detachably (permanently) connected to the compartment 31.

The neck 33 can include a rigid structure and/or a flexible structure. As shown, the handle 10 includes an opening 14 in the top end 15 of the handle 10 and the neck 33 is a rigid structure that extends through the opening 14. The neck 33 can be releaseably connected to the handle 10 proximate the opening 14 in the top end 15 of the handle 10. Preferably, the neck 33 can form a snap-fit connection with the sidewalls 21 of the opening 14 in the handle 10. For example, the handle 10 may include deflectable arms 22 proximate the opening 14 and the arms 22 deflect outward when the neck 33 is being inserted into and/or removed from the opening 14. The arms 22 hold the neck in the opening 14 and hence the brush/dentifrice compartment unit 30 to the handle unit 10.

In an alternate embodiment shown in FIG. 7, the toothbrush system 1 may include a handle 10 having a handle neck 23 connected to and extending from the top end 15 of the body 11. This type of structure may be used, for example, where the neck 33 is a flexible structure. A channel 24 may be formed in the handle neck 23 for receiving and retaining the neck 33 of the brush/dentifrice compartment unit 30. The handle 10 would also include a handle head 25 formed at a top end 15 of the handle neck 23. A recess 26 may be formed in said handle head 25 for receiving and retaining the brush 36. The neck 33 is releaseably connected to the channel 24 in the handle neck 23 and the brush 36 is releaseably connected to the recess 26 in the handle head 25. For example, the neck 33 may form a snap-fit connection with the channel 24 in the handle neck 23 and the brush 36 forms a snap-fit connection with the recess 26 in the handle head 25.

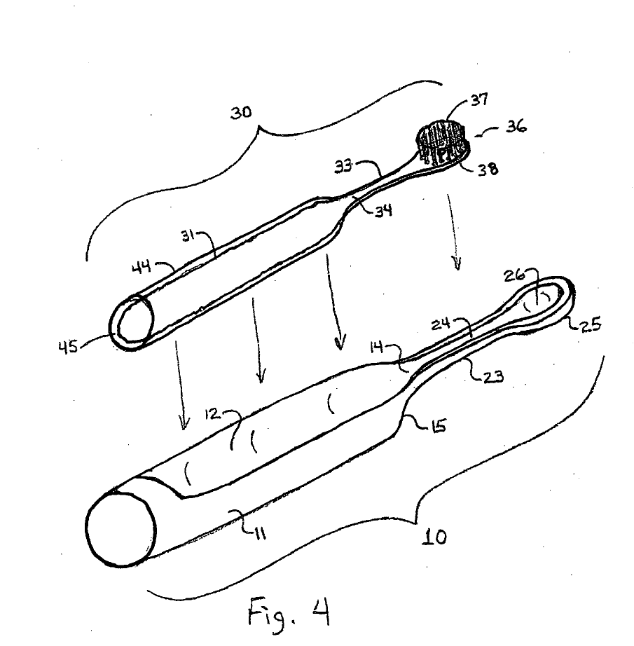

In another exemplary embodiment, brush/dentifrice compartmpent unit 30 can include an encasement 28. The encasement 28 protects the compartment 31 from accidental compression and discharge of dentifrice. As shown in FIG. 4, an encasement 44 can extend from the neck and surround the compartment 31. An opening 45 may be provided at the bottom of the encasement 44 for compression of the compartment 31 and dispensing of the dentifrice. Preferably, the encasement 44 is a see-through material, such as for example, a clear plastic material, that allows the user to see the compartment 31 in order to access the status of the compartment 31, such as, for example, to determine the type of dentifrice that is inserted in the handle 10, the amount of dentifrice that remains in the compartment 31, etc.

The brush 36 includes a plurality of bristles 37 extending from a head 38. As shown in FIG. 3, the passageway 34 extends from the neck 33 into the head 38 of the brush 36. As shown, the head 38 includes a surface 39 having one or more dentifrice dispensing apertures 40. The dentifrice dispensing apertures 40 are located proximate the bristles 37. The passageway 34 in the neck 33 is fluidly connected to the one or more dentifrice dispensing apertures 40. The dentifrice dispensing apertures 40 may include a variety of shapes, such as circular openings, slotted openings, etc.

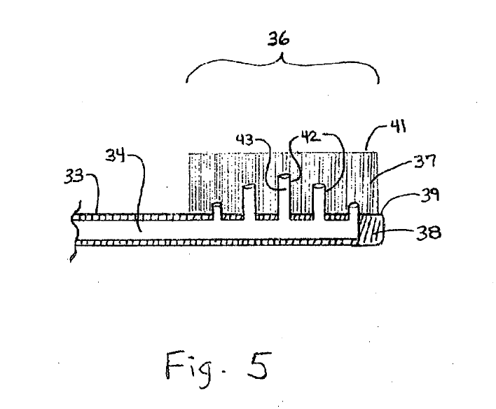

It is desirable to have the dentifrice material applied above the brush head surface 39 and preferably near the distal end 41 of the bristles 37. In one embodiment, the brush 36 can include one or more bristle tubes 42 connected at one end to the brush head 38 proximate the one or more dentifrice dispensing apertures 40. As shown in FIG. 5, the bristle tubes 42 extend from the head 38 in the same direction as the bristles 37 and in between the bristles 37. The bristle tubes 42 have a passageway 43 that fluidly connects with the dentifrice dispensing apertures 40 and the passageway 34 in the neck 33. In addition, where multiple bristle tubes 42 are employed, the length of the bristle tubes 42 may vary to apply the dentifrice through out the height of the bristles 37. Preferably, the bristle tube 42 is made from a soft flexible material, similar to the bristles 37.

Proper brushing is essential for effective cleaning of teeth and gums and proper brush selection is essential for helping to achieve proper brushing. The brush 36 can include various designs, such as size, shape, and the like. For example, FIG. 1 shows a brush 36 having a generally rectangular shaped head and bristle arrangement and FIG. 6 shows a brush 36 having a generally oval shaped head and bristle arrangement. The size and shape of the brush 36 should fit the user's mouth and personal preferences, allowing the user to reach all areas of the mouth and teeth easily and effectively. Preferably, the bristles 37 include soft, nylon, round-ended bristles that will not scratch and irritate teeth or damage gums. Bristles 37 may be available in various types and sizes. The length of the bristles 37 above the surface 39 of the brush head 38 may vary to form multi-level brushing surfaces (not shown) at the distal ends 41 of the brush bristles 37.

During use, the compartment 31 is compressed causing the dentifrice material to be forced out of the opening 32 in the compartment 31. Dentifrice material exists the compartment 31 and flows through the passageway 34 in the neck 33 and brush head 38 and out of the one or more dentifrice dispensing apertures 40 proximate the bristles 37. This self-contained brush/denfifrice compartment unit 30 eliminates and/or reduces the chance of contaminants contacting and/or mixing with the dentifrice material during storage and application of the dentifrice at the bristles 37 prior to use.

In one embodiment, the compartment 31 can be manually compressed by the user. In the embodiment shown in FIGS. 1 and 2, the user can use a thumb or finger to manually press-on or push-up the compartment 31 causing dentifrice to be dispensed at the bristles 37. A door 16 may be employed to cover the compartment 31 and avoid inadvertent compression of the compartment 31 positioned in the handle cavity 12. If a door 16 is employed, then the user opens the door 16 prior to compressing the compartment 31. After proper dispensing of the dentifrice, the door 16 can be closed and brushing commenced. This embodiment provide a simple design that is easy to use and does not include a lot of parts.

The toothbrush system 1 can include a dispensing system. In one embodiment, the dispensing system can include a manual dispensing system 50a. In one preferred embodiment shown in FIGS. 6 and 7, the manual dispensing system 50a includes a twist-style control knob 51, a stem 52, and a base 53. The manual dispensing system 50a can be positioned in the same handle cavity 12 as the compartment 31. In this embodiment, the handle 10 would include a hollow body or shell 11 surrounding the cavity 12. Alternatively, the manual dispensing system could be positioned in a separate cavity or chamber 54 formed below the compartment cavity 12 in the lower portion 27 of the handle 10. In yet another embodiment, the manual dispensing system 50a could be location in the cavity 12 around the side of the compartment 31 and could move toward the center of the cavity 12 during the dispensing operation to compress the compartment 31 and dispense dentifrice.

As shown in FIGS. 6 and 7, the base 53 would contact the compartment 31 and as the control knob 51 is operated (e.g., twisted), the base 53 to travel upward along the stem 52 and compress the compartment 31. Preferably, the width or diameter of the base 53 is slightly smaller that the width or diameter of the cavity 12. If the control knob 51 is turned in the opposite direction to base 53 would travel downward.

FIG. 8 is a partial cross-sectional view of the brush/dentifrice compartment unit 30 showing an encasement 44 surrounding the compartment 31. As shown a base 53 passes through an opening 45 in the bottom of the encasement 44 and contacts the compartment 31. As the dispensing system is activated, the base 53 compresses the compartment 31 and causes dentifrice to be dispensed at the brush 36.

In another embodiment, the manual dispensing system could include a lever (not shown) to move the base 53 upward to compress the compartment 31. The lever can be connected to the base 53 and extend through a slot (not shown) in the side of the handle body 11. The user would slide the lever upward to compress the compartment 31. The lever could include a rotating or sliding mechanism.

In another embodiment, a pump (not shown) could be used to move the base 53 upward or alternatively, the pump could be used to increase the air pressure within the cavity 12 to compress the compartment 31. Alternatively, a side rail system (not shown) could be used as part of the dispensing system.

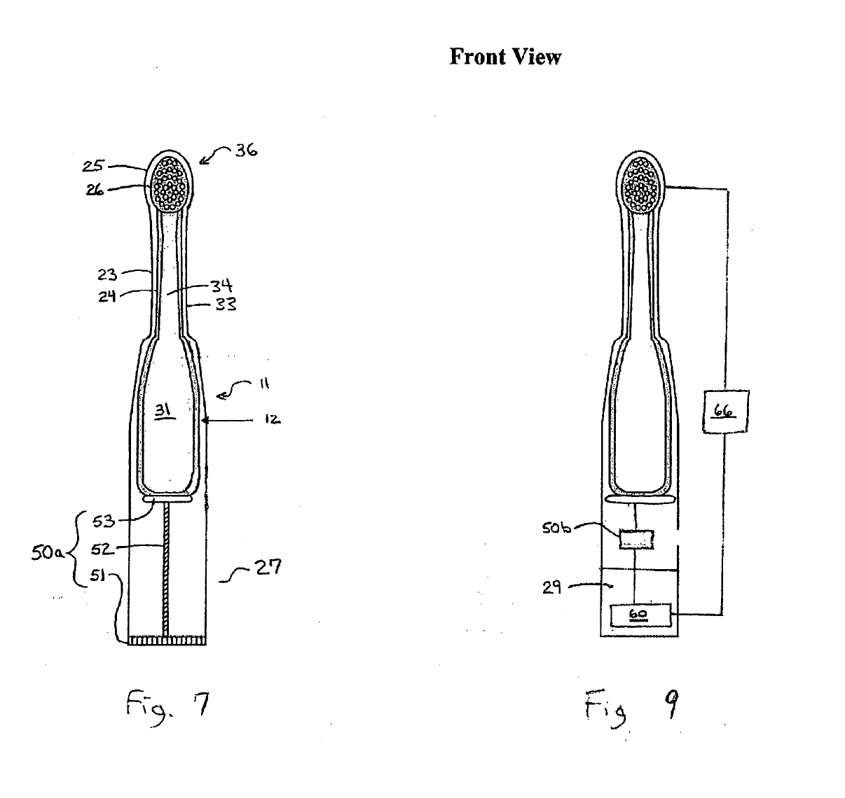

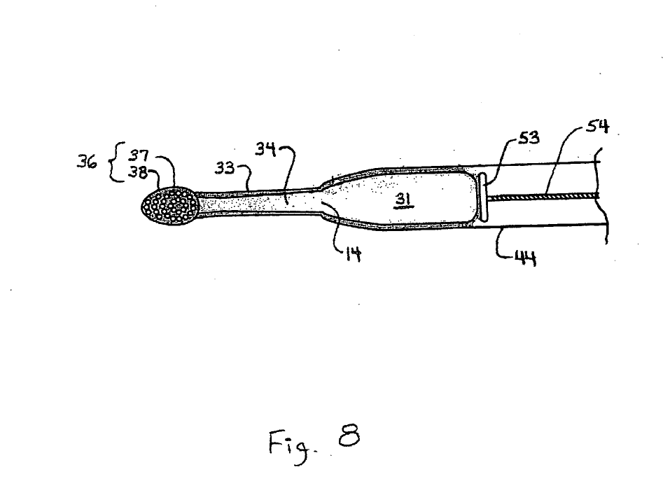

In yet another embodiment, the dispensing system can include an automatic dispensing system. FIGS. 9-11 show an alternate embodiment of the toothbrush system 1 including an automatic dentifrice dispensing system and an automatic brushing system. Preferably, a second cavity or chamber 29 is provided in the lower portion 27 of the handle unit 10 of automatic toothbrush systems to house the power supply 60 and portions of the automatic dentifrice dispensing system.

As shown in FIG. 9, the automatic toothbrush system includes the power supply 60 that is connected to an automatic dentifrice dispensing system 50b and/or an automatic brushing system. The an automatic dentifrice dispensing system 50b can include a motor and associated linkage to move the base 53 upward to compress the compartment 31 and dispense the dentifrice at the brush 36. The automatic brushing system 66 can use the same motor as the dentifrice dispensing system 50b or a separate motor and associate linkage to the brush head and bristles. The automatic brushing system 66 can vibrate, rotate, and/or oscillate the brush head and/or bristles.

As shown in FIG. 10, the automatic toothbrush system includes an on/off button 61 for the automatic brushing system. As shown in FIG. 10, the automatic toothbrush system can include a dispensing button 62 for automatic dispensing of the dentifrice. The dispensing button 62 may include a serrated dispensing button 62 that snaps up and down for automatic dispensing of the dentifrice. Preferably, the dispensing button 62 is held in the dispensing position by the user and snaps back into the off position when released by the user. This helps to prevent the accidental discharge of dentifrice. As shown, the automatic toothbrush system can also include a timer 20 for helping to ensure that the user brushes for the proper length of time to facilitate proper teeth cleaning.

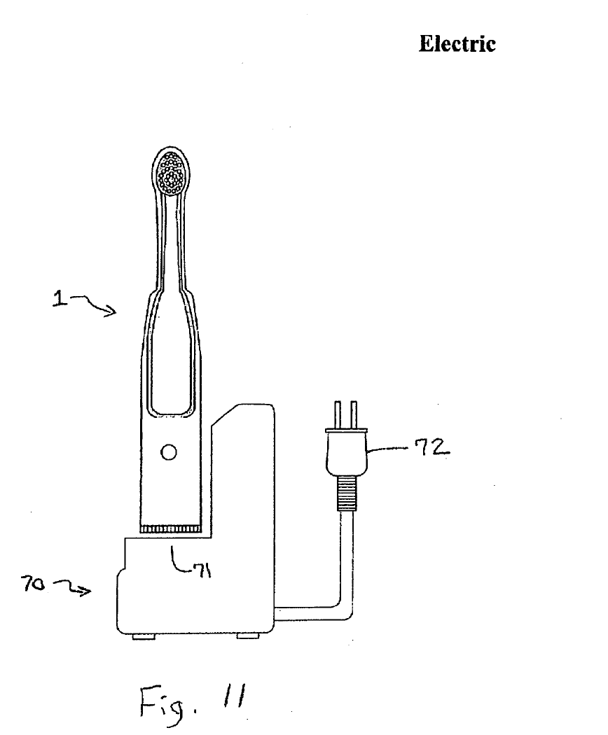

The automatic toothbrush system includes a power supply 60. The power supply 60 can be a battery or an electric cord. The battery may include rechargeable batteries. FIG. 11 shows an automatic toothbrush system positioned in a base 70. As shown, the base 70 includes a cradle 71 for receiving and holding the handle portion 10 of the toothbrush system 1. The base 70 includes a power cord 72 for plugging the base 70 into a power outlet (not shown). The base 70 can be used to hold the toothbrush system 1 when it is not being used and also to recharge the power supply 60 of the toothbrush system 1.

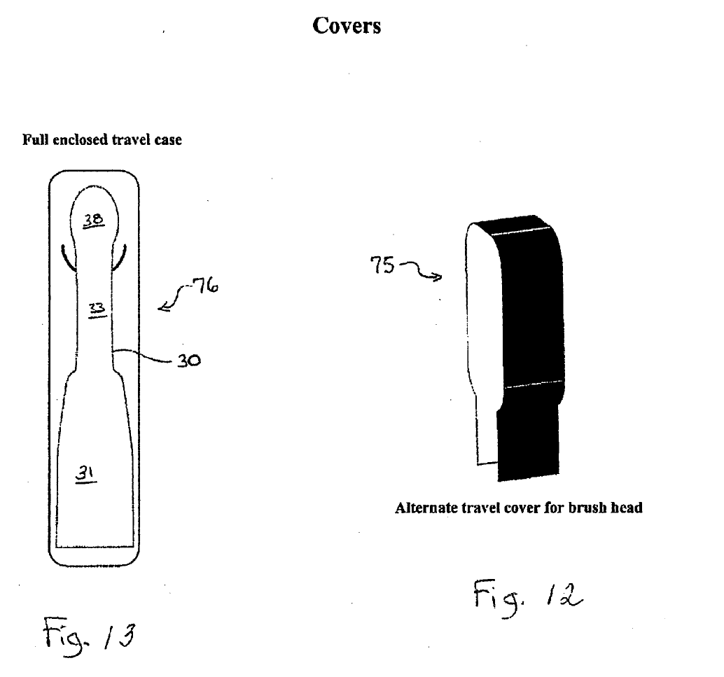

FIG. 12 shows an exemplary brush cover 75 that can be used with the toothbrush system 1. The cover 75 is sized to cover at least the brush head 38 and bristles 37 and protects the brush 36 from damage and contamination. Preferably, the cover 75 is made from a semi-rigid material, such as a plastic material.

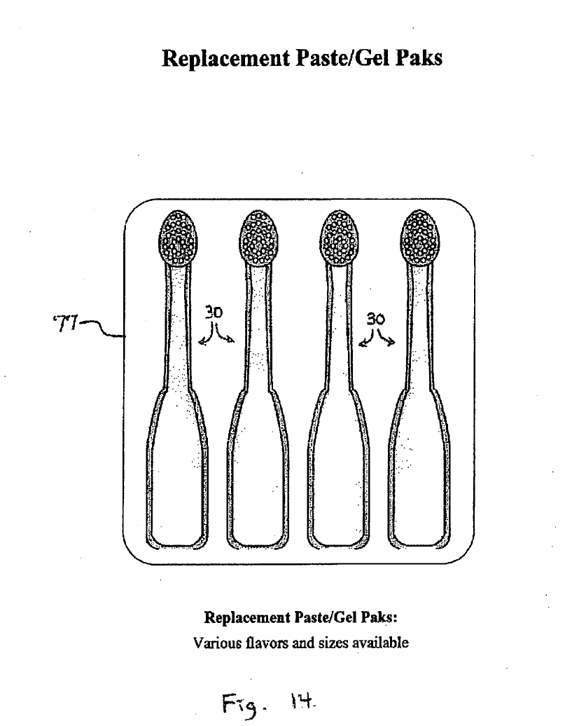

In an embodiment having an encasement 28 surrounding the compartment 31, the compartment 31 is not susceptible to accidental compression and discharge of dentifrice when the brush/dentifrice compartment unit 30 is removed from the handle unit 10 due to hard plastic encasement 28. In an embodiment not having an encasement 28, the compartment 31 may be susceptible to accidental compression and discharge of dentifrice at the brush 36 when the brush/dentifrice compartment unit 30 is removed from the handle unit 10. Since multiple user may be using-the same handle 10, it is possible that users may be traveling with brush/dentifrice compartment units 30 that are removed from the handle unit 10. To this end, a protective travel case 76 may be used to protect the brush/dentifrice compartment unit 30 and to prevent the accidental discharge of dentifrice from the compartment 31. FIG. 13 shows an exemplary case 76 that can be used to store the brush/dentifrice compartment unit 30 during travel. The case 76 is sized to cover at least the brush/dentifrice compartment unit 30 and protects the brush/dentifrice compartment unit 30 from damage and the compartment 31 from accidental compression. Preferably, the case 76 is made from a semi-rigid material, such as a plastic material. In one embodiment, the packaging container (not shown) that the new brush/dentifrice compartment unit are sold in may be re-usable as a travel case 76.

FIG. 14 shows an exemplary package 77 for holding one or more replacement toothbrush and dentifrice storage sub-systems. As shown, the package 77 can include a plurality of replacement brush/dentifrice compartment units 30. The brush/dentifrice compartment units 30 stored in the package 77 can include various combinations of flavors, type of dentifrice, type of brush, size, shape, etc.

The improved toothbrush system in accordance with the present invention provides numerous advantages and benefits over conventional toothbrush system. The improved toothbrush system provides greater variety in that each handles unit and each brush/dentifrice compartment unit can be sold and used separately or in various combinations, as desired. For example, each handle may be used with various replacement brush heads and various types and flavors of dentifrice. The replaceable brush/dentifrice compartment units can be packaged and sold in various combinations of brush head types, dentifrice types (powder, paste, gel, liquid, whiteners and combinations of dentifrice and mouth fresheners), and dentifrice flavors.

The improved toothbrush system provides for better oral hygiene. The self-contained dentifrice dispensing system of the integral brush/dentifrice compartment unit provides improved sanitation and reduces messy pastes and gels on sinks, counters and cabinets. The integral brush/dentifrice compartment unit and self-contained dentifrice dispensing system also prevent oral contact between the dentifrice and the brush bristles and cross-contamination between multiple users.

The improved toothbrush system of the present invention is also easy to use and is more convenient to use both at home or on travel. The improved toothbrush system also allows for completely manual operation, partial manual and partial automatic operation, and for completely automatic operation. Further, the improved toothbrush system helps the user comply with the American Dental Association recommendation of changing the brush portion a minimum of four times per year. The improved toothbrush system also allows for the reuse of the portions of the toothbrush system that are still in good working order, such as the handle portion.

While apparatus and systems have been described and illustrated with reference to specific embodiments, those skilled in the art will recognize that modification and variations may be made without departing from the principles described above and set forth in the following claims. Accordingly, reference should be made to the following claims as describing the scope of disclosed embodiments.

1. An oral care system comprising:
a handle having a cavity therein;
a brush having a plurality of bristles extending from a head;
one or more apertures in said head proximate said bristles;
a compartment that is disposed in said cavity and comprises at least one dentifrice material;
a neck extending between said brush and said compartment;
a passageway in said neck fluidly connecting said compartment and said apertures;
wherein said brush, said neck, and said compartment are formed as a substantially integral unit that is detachably connected to said handle.

2. The system of claim 1, wherein said brush, said neck, and said compartment are non-detachably connected to one another to form a self-contained dentifrice dispensing system.

3. The system of claim 1, further comprising a dispensing mechanism for compressing said compartment.

4. The system of claim 3, wherein said dispensing mechanism comprises:
a base positioned within said cavity for engaging said compartment;
a stem connected to said base at a first end;
a control knob connected to a second end of said stem opposite said fist end, said knob accessible from an exterior of said handle;
wherein said base travels upward and compresses said compartment when said knob is activated.

5. The system of claim 4, further comprising an encasement extending from said neck and surrounding said compartment, said encasement having an opening at a bottom end, wherein said base passes through said opening and travels upward into said encasement as said control knob is activated to compress said compartment.

6. The system of claim 1, further comprising:
an opening in a top end of said handle; and
wherein said neck is rigid and extends through said opening in said top end of said handle.

7. The system of claim 6, wherein said neck is releaseably connected to said handle proximate said opening in said top end of said handle.

8. The system of claim 6, wherein said neck forms a snap-fit connection with said opening in said top end of said handle.

9. The system of claim 6, wherein said handle further comprises deflectable arms proximate said opening in said top end of said handle, wherein said arms deflect outward when said neck is inserted into or removed from said opening, said arms holding said neck in said opening in said top end of said handle.

10. The system of claim 6, wherein said neck further comprises threads and wherein said neck is threadably connected to said handle through said opening in said top end.

11. The system of claim 1, further comprising a retainer ring for releaseably connecting said neck to said handle.

12. The system of claim 1, further comprising:
a handle neck connected to and extending from a top end of said handle;
a channel formed in said handle neck for receiving and retaining said neck;
a handle head at a top end of said handle neck; and
a recess formed in said handle head for receiving and retaining said brush head.

13. The system of claim 12, wherein said neck is releaseably connected to said channel in said handle neck and said brush head is releaseably connected to said recess in said handle head.

14. The system of claim 12, wherein said neck forms a snap-fit connection with said channel in said handle neck and said brush head forms a snap-fit connection with said recess in said handle head.

15. The system of claim 12, wherein said neck is flexible.

16. The system of claim 1, further comprising an encasement extending from said neck and surrounding said compartment.

17. The system of claim 1, further comprising a door that is connected to said handle and overlays said compartment positioned in said cavity.

18. The system of claim 1, further comprising an ejector in said handle, wherein ejector ejects said brush/dentifrice compartment unit from said handle.

19. The system of claim 1, further comprising one or more grips in said handle.

20. The system of claim 1, further comprising one or more bristle tubes that are connected to said one or more dentifrice dispensing apertures and extend from said brush head between said bristles.

21. The system of claim 1, further comprising an automatic toothbrush system comprising:
a power supply; and
a motor.

22. The system of claim 21, wherein said automatic toothbrush system further comprises an automatic dentifrice dispensing system, said automatic dentifrice dispensing system comprising:
linkage connected between an output shaft of said motor and a base; and
a dentifrice dispensing button electrically coupled between said power supply and said motor;
wherein said power supply energizes said motor when said dentifrice dispensing button is activated, said motor causing said motor output shaft to rotate and said linkage to move said base and compress said compartment causing dentifrice to be dispensed at said bristles.

23. The system of claim 21, wherein said automatic toothbrush system further comprises an automatic brushing system, said automatic brushing system further comprising:
linkage connected to an output shaft of said motor and said brush head; and
an on/off button electrically coupled between said power supply and said motor;
wherein said power supply energizes said motor when said on/off button is activated, said motor causing said motor output shaft to rotate and said linkage to one of vibrate, rotate, and oscillate one of said brush head and said bristles for improved oral hygiene.

24. The system of claim 21, wherein said automatic toothbrush system further comprises an automatic dentifrice dispensing system and an automatic brushing system, said automatic dentifrice dispensing system and said an automatic brushing system comprising:
linkage connected between an output shaft of said motor and a base;
a dentifrice dispensing button electrically coupled between said power supply and said motor;
wherein said power supply energizes said motor when said dentifrice dispensing button is activated, said motor causing said motor output shaft to rotate and said linkage to move said base and compress said compartment causing dentifrice to be dispensed at said bristles;
linkage connected to an output shaft of said motor and said brush head; and
an on/off button electrically coupled between said power supply and said motor;
wherein said power supply energizes said motor when said on/off button is activated, said motor causing said motor output shaft to rotate and said linkage to one of vibrate, rotate, and oscillate one of said brush head and said bristles for improved oral hygiene.

25. Canceled.

26. The system of claim 21, wherein said automatic toothbrush system further comprises a base for cradling and recharging said automatic toothbrush system.

27. The system of claim 1, further comprising a cover for enclosing at least said brush head and said bristles.

28. The system of claim 1, further comprising a case for enclosing said brush/dentifrice compartment unit when said brush/dentifrice compartment unit is removed from said handle unit.

29. An oral care system comprising a handle portion and a brush/dentifrice compartment portion that is detachably coupled to said handle portion:
said handle portion comprising:
a rigid body;
a cavity in said body;
an opening in a top end of said body;
said brush/dentifrice compartment portion comprising:
a rigid brush head;
a plurality of flexible bristles extending from said brush head;
one or more dentifrice dispensing apertures in said brush head proximate said bristles;
a rigid neck formed between said brush head and said compartment, said neck extending through said opening in said top end of said handle portion;
a collapsible compartment storing a dentifrice material, said compartment positioned within said cavity;
a passageway passing through said neck and fluidly connecting said compartment to said one or more dentifrice dispensing apertures;
wherein said compartment, said passageway, and said one or more apertures form a self-contained dentifrice dispensing system.

30. A toothbrush and dentifrice storage sub-system comprising:
a brush portion comprising:
a rigid platform;
a plurality of bristles extending from one side of said platform;
one or more apertures in said platform proximate said bristles;
an elongate neck extending from said platform;
a passageway in said elongate neck, said passageway fluidly connected to said one or more apertures;
a dentifrice storage portion non-detachably connected to said brush portion, said dentifrice storage portion comprising:
a flexible wall defining a belly;
an opening in said flexible wall, said opening fluidly connected to said passageway;
a dentifrice material stored within said belly;
wherein said dentifrice material flows from said belly, through said opening in said flexible wall, through said passageway in said neck, and through said one or more dispensing apertures in said head portion.

31. The system of claim 30, wherein said brush portion and said dentifrice storage portion are formed as a single, integral unit having a self-contained dentifrice dispensing system.

32. The system of claim 30, further comprising a package for holding one or more of said toothbrush and dentifrice storage sub-systems.
